(19) United States
(12) Patent Application Publication
(10) Pub. No.: US 2026/0093534 A1
(43) Pub. Date: Apr. 2, 2026

(54) RECORDING MEDIUM, MEMORY RELEASE PROCESSING METHOD, AND INFORMATION PROCESSING DEVICE

(71) Applicant: Fujitsu Limited, Kawasaki-shi (JP)

(72) Inventors: Yu URYU, Yokohama (JP); Koji KURIHARA, Kawasaki (JP)

(73) Assignee: Fujitsu Limited, Kawasaki-shi (JP)

(21) Appl. No.: 19/339,382

(22) Filed: Sep. 25, 2025

(30) Foreign Application Priority Data
Sep. 30, 2024 (JP) 2024-171347

(51) Int. Cl. G06F 9/50

(52) U.S. Cl. CPC G06F 9/5022; G06F 9/5016; G06F 9/5033

(57) ABSTRACT

A computer-readable recording medium stores a program for causing a computer to execute a process including: identifying an available capacity of a memory of any GPU sharable by two or more programs including a target program having a process that is repeatedly executed using a machine learning model, the available capacity being identified when any GPU is assigned to the process of the target program; determining whether the memory is insufficient based on a comparison of the identified available capacity and a memory usage measured during a previous execution of the process of the target program; executing the process of the target program by any GPU when the memory is sufficient; and holding execution of the process of the target program by the any GPU, when the memory is insufficient, the execution of the process being held until, in the memory, a storage area assigned to another program is released.

### CROSS REFERENCE TO RELATED APPLICATIONS

This application is based upon and claims the benefit of priority of the prior Japanese Patent Application No. 2024-171347, filed on September 30, 2024, the entire contents of which are incorporated herein by reference.

### FIELD

Embodiments discussed herein relate to a recording medium, a memory release processing method, and an information processing device.

### BACKGROUND

Conventionally, there is a technique for dynamically switching resources for executing applications to improve the resource utilization rate of the entire system. For example, when executing multiple programs, there is a technique that distinguishes between programs that are better processed by a graphics processing unit (GPU) and programs that may be processed by a central processing unit (CPU) by, for example, predicting the speedup rate, and the technique assigns a GPU to the process of the program having a high priority.

As a prior art, for example, there is a technique in which a host system adds data to an update log on a host memory to reflect the data added to the host-side update log in an update log on a device memory via an I/O bus so that the GPU reflects the data reflected on the update log in a parallel processing data structure. There is also a technique in which a graphics processing unit includes a VRAM cache module to provide and manage additional cache resources for a central processing unit. There is also a technique in which by determining an optimal path for transferring a calculation result, the calculation result of a first calculating unit is transferred to a second calculating unit using the determined optimal path. There is also a technique related to memory management for a heterogeneous system such as a system including a CPU and a GPU. For example, refer to Japanese Laid-Open Patent Publication No. 2022-23618, Published Japanese-Translation of PCT Application, Publication No. 2012-515992, U.S. Patent Application Publication No. 2021/0209471, and U.S. Patent Application Publication No. 2023-0032278.

### SUMMARY

According to an aspect of an embodiment, a computer-readable recording medium stores therein a memory release processing program for causing a computer to execute a process, the process including: identifying an available capacity of a memory of any GPU sharable by two or more programs including a target program having a process that is repeatedly executed using a machine learning model, the available capacity being identified when the any GPU is assigned to the process of the target program; determining whether the memory is insufficient based on a result of comparison of the identified available capacity of the memory and a memory usage measured during a previous execution of the process of the target program; executing the process of the target program by the any GPU when the memory is sufficient; and holding execution of the process of the target program by the any GPU, when the memory is insufficient, the execution of the process being held until, in the memory, a storage area assigned to another program is released.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram depicting an example of a memory release processing method according to an embodiment.

FIG. 2 is an explanatory diagram depicting a system configuration example of an information processing system 200.

FIG. 3 is a block diagram depicting a hardware configuration example of an execution control device 201.

FIG. 4 is an explanatory diagram depicting an example of storage contents of a memory usage management table 220.

FIG. 5 is an explanatory diagram depicting an example of storage contents of an available memory management table 230.

FIG. 6 is a block diagram depicting an example of a functional configuration of the execution control device 201.

FIG. 7 is an explanatory diagram depicting an example of operation of the execution control device 201.

FIG. 8 is an explanatory diagram depicting an example of determining whether there is a shortage of available memory.

FIG. 9 is an explanatory diagram depicting an example of data transfer before and after application of a memory release processing method.

FIG. 10 is an explanatory diagram depicting an example of data transfer before and after application of the memory release processing method.

FIG. 11 is a flowchart depicting an example of a memory release processing procedure of the execution control device 201.

FIG. 12 is a flowchart depicting an example of the memory release processing procedure of the execution control device 201.

FIG. 13 is a flowchart depicting an example of an execution control process procedure of the execution control device 201.

FIG. 14 is an explanatory diagram depicting an example of a change in GPU usage rate.

### DESCRIPTION OF EMBODIMENTS

First, problems associated with the conventional techniques are discussed. The conventional techniques have a problem in that when executing a program repeatedly performing processing that uses a machine learning model, the utilization rate of the GPU may decrease.

Embodiments of a recording medium, a memory release processing method, and an information processing device according to the present disclosure are described in detail with reference to the accompanying drawings.

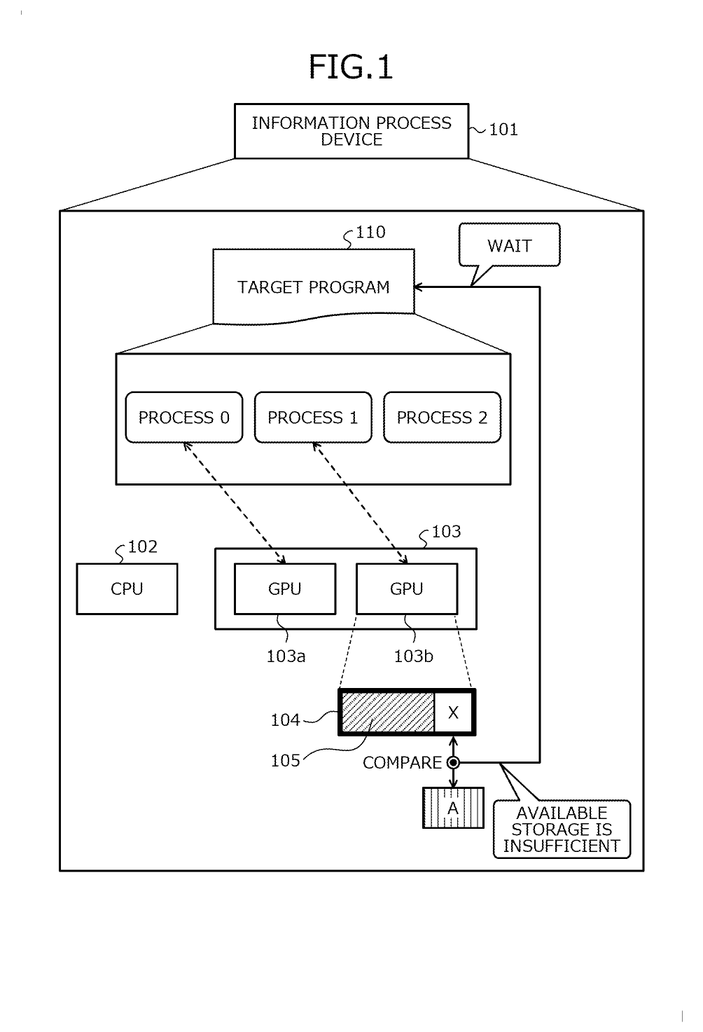

FIG. 1 is an explanatory diagram depicting an example of a memory release processing method according to an embodiment. In FIG. 1, an information processing device 101 is a computer that controls the execution of a target program 110. The target program 110 is a program to be executed such as, for example, a user program.

The target program 110 includes a process that is repeatedly executed using a machine learning model. The machine learning model is generated by machine learning such as deep learning. The machine learning model is specified by, for example, an algorithm and a parameter (weight parameter).

A process of the target program 110 may be, for example, a training process of a machine learning model using all the training data in the dataset. A process of the target program 110 may also be an estimation process using a machine learning model (trained model) for each input data group.

A CPU 102 and a GPU 103 are arithmetic devices that may be used to execute the target program 110 or other programs, and each may be shared by two or more programs. The CPU 102 and the GPU 103 may be included in the information processing device 101, or may be included in a computer different from the information processing device 101. There may be two or more CPUs 102 and GPUs 103. In the example of FIG. 1, two devices, GPUs 103a and 103b, are assumed as the GPUs 103.

Here, a process using a machine learning model is often more suitable for a GPU (e.g., GPU 103) than a CPU (e.g., CPU 102), and there is a tendency that the process may be performed faster by a GPU than by a CPU. On the other hand, the number of available GPUs is limited, and when multiple programs are executed, it may not be possible to assign a GPU to the process of all the programs.

For this reason, there is a conventional technique for scheduling in which, when multiple programs are executed, a program that is better processed by a GPU and a program that may be processed by a CPU are distinguished from each other by measuring the performance when executed by the GPU and the CPU, and a GPU is assigned to the process of a program having a high priority.

To use a GPU, data necessary for execution is moved to a memory of the GPU. For example, in a process using a machine learning model, model data is moved. Model data is information that represents a machine learning model, and includes, for example, information that specifies the algorithm and parameters (weight parameters) of the machine learning model.

In the following description, the movement of data necessary for the execution of a program (for example, the target program 110) may be referred to as "data transfer." The movement of model data among data transfers may be referred to as "model transfer." Data other than model data among data necessary for the execution of a program may be referred to as "input/output data," and the movement of input/output data may be referred to as "input/output data transfer." Input/output data may be, for example, a data set of training data, or input data and output data for a machine learning model (trained model).

However, when a program that repeatedly performs processing using a machine learning model is executed, the longer the data transfer time, the lower the GPU utilization rate. The GPU utilization rate corresponds, for example, to a sum of the data processing time divided by the total time. The data processing time is the time necessary for each process of the program to be executed by the GPU. The total time is the time necessary until the execution of the entire program is completed.

For example, in the conventional technique, to free up the GPU, memory is released each time one process of the program is completed. The data stored in the memory of the GPU is, for example, saved to the memory of the CPU. Therefore, in the conventional technique, data transfer is performed each time the process of the program is completed.

For example, assume that the process of the target program 110 is a training process of a machine learning model and is executed three times while switching the data set. Here, a process executed the first time among the processes of the target program 110 is represented as "process 0," a process executed the second time is represented as "process 1," and a process executed the third time is represented as "process 2."

In this case, in the conventional technique, when a GPU is assigned to process 0, data transfer is first performed to move data necessary for the execution of process 0 to the GPU, and process 0 is executed by the GPU. When the execution of process 0 is completed, data transfer is performed to save data in the memory of the GPU to the memory of the CPU, etc., and the memory of the GPU is released.

The data transfer time is a combination of the model transfer time and the input/output data transfer time. Thereafter, the same processing as for process 0 is performed for process 1 and process 2. In a process using a large-scale machine learning model, the amount of model data is large, and model transfer becomes a bottleneck in improving the utilization rate of the GPU.

Thus, to improve the utilization rate of the GPU, it is desirable to reduce the number of model transfers. The model data is the same between processes using a machine learning model. For this reason, it is possible to set the timing of releasing the memory of the GPU when the execution of the program process starts, rather than when the execution of the program process ends.

As a result, when a GPU is assigned to the process of a program and the same GPU as in the previous execution is assigned, the model data in the memory of the GPU may be reused and model transfer may be omitted. On the other hand, when a GPU different from the previous execution is assigned, the memory of the GPU assigned in the previous execution may be released to free up the GPU.

However, by setting the timing of releasing the memory of the GPU at the beginning of the execution of the program process, there is a possibility that sufficient memory cannot be secured when the GPU is assigned. When memory for storing data necessary for execution of a program process cannot be secured even though a GPU has been assigned, an error such as out-of-memory may occur, which may result in a decrease in the efficiency of GPU usage.

In this embodiment, therefore, a memory release processing method for managing memory on a GPU will be described, taking into consideration a case in which memory capacity for storing data necessary for execution cannot be secured when a GPU is assigned. Here, an example of processing by the information processing device 101 (corresponding to the following processing (1) to (3)) will be described.

(1) When one of the GPUs 103 is assigned to a process of the target program 110, the information processing device 101 identifies available memory capacity on the GPU 103. Here, it is assumed that the process of the target program 110 is "process 1" to be executed for the second time and that the GPU 103b is assigned to process 1. It is assumed that the first process 0 has been assigned to the GPU 103a and executed.

In this case, when the GPU 103b is assigned to the process 1 of the target program 110, the information processing apparatus 101 identifies an available capacity of a memory 104 on the GPU 103b. Here, it is assumed that a storage area 105 in the memory 104 is being used by another program and that the available capacity of the memory 104 is "X [GB]."

(2) The information processing device 101 compares the identified available capacity of the memory 104 with the memory usage measured during the previous execution of the process of the target program 110. Then, based on the result of the comparison, the information processing device 101 determines whether the memory 104 is insufficient.

Here, the memory usage corresponds to the storage capacity necessary for executing the process of the target program 110. When a storage area for this memory usage cannot be secured in the memory 104, it may be said that the memory 104 is insufficient and an error may occur when the GPU 103b executes the process 1.

Here, it is assumed that the memory usage "A [GB]" measured during the first execution of the process 0 is recorded. In this case, the information processing device 101 compares the available capacity "X [GB]" of the memory 104 with the memory usage "A [GB]." Then, the information processing device 101 determines whether the memory 104 is insufficient based on the result of the comparison.

For example, when the available capacity "X [GB]" of the memory 104 is equal to or greater than the memory usage "A [GB]," the information processing device 101 judges that the memory 104 is not insufficient. On the other hand, when the available capacity "X [GB]" of the memory 104 is less than the memory usage "A [GB]," the information processing device 101 judges that the memory 104 is insufficient.

Here, it is assumed that the available capacity "X [GB]" of the memory 104 is less than the memory usage "A [GB]." In this case, the information processing device 101 judges that the memory 104 is insufficient.

(3) When the memory 104 is sufficient, the information processing device 101 executes the process 1 of the target program 110 by the GPU 103b. When the memory 104 is insufficient, the information processing device 101 holds the execution of the process 1 of the target program 110 by the GPU 103b until a storage area in the memory 104 assigned to another program is released.

Here, the memory 104 is insufficient. In this case, the information processing device 101 holds the execution of the process 1 of the target program 110 by the GPU 103b until a storage area in the memory 104 assigned to another program (for example, the storage area 105) is released.

For example, the information processing device 101 holds the execution of the process 1 until a storage area in the memory 104 is released and the available capacity in the memory 104 becomes at least equal to or greater than the memory usage amount "A [GB]." Then, when the available capacity in the memory 104 becomes equal to or greater than the memory usage "A [GB]," the information processing apparatus 101 executes the process 1 by the GPU 103b.

As described, the information processing apparatus 101 may improve the utilization rate of the GPUs 103 by suppressing the occurrence of an error caused by a failure to secure a memory area necessary for executing a process of the target program 110 when one of the GPUs 103 is assigned to the process of the target program 110.

In the example of FIG. 1, the memory 104 is insufficient when the GPU 103b is assigned to the process 1 of the target program 110. Therefore, the information processing apparatus 101 holds execution of the process 1 of the target program 110 by the GPU 103b until the memory area in the memory 104 assigned to another program is released. As a result, even when the timing for releasing memory in one of the GPUs 103 is set to the beginning of execution of the program process, the information processing device 101 may secure a sufficient storage area in the memory 104 on the GPU 103 during execution of process 1, thereby preventing errors such as out-of-memory from occurring.

Next, a system configuration example of an information processing system 200 including the information processing device 101 depicted in FIG. 1 will be described. Here, an example will be described in which the information processing device 101 depicted in FIG. 1 is applied to an execution control device 201 in the information processing system 200.

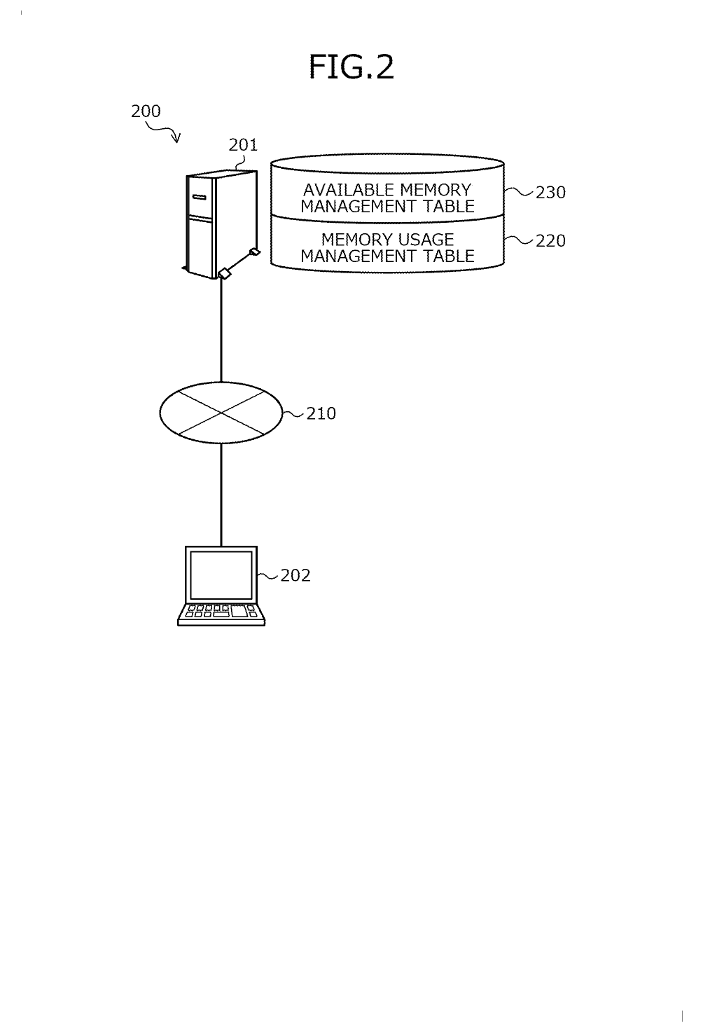

FIG. 2 is an explanatory diagram depicting a system configuration example of the information processing system 200. In FIG. 2, the information processing system 200 includes the execution control device 201 and a user terminal 202. In the information processing system 200, the execution control device 201 and the user terminal 202 are coupled via a wired or wireless network 210. The network 210 is, for example, the Internet, a local area network (LAN), or a wide area network (WAN).

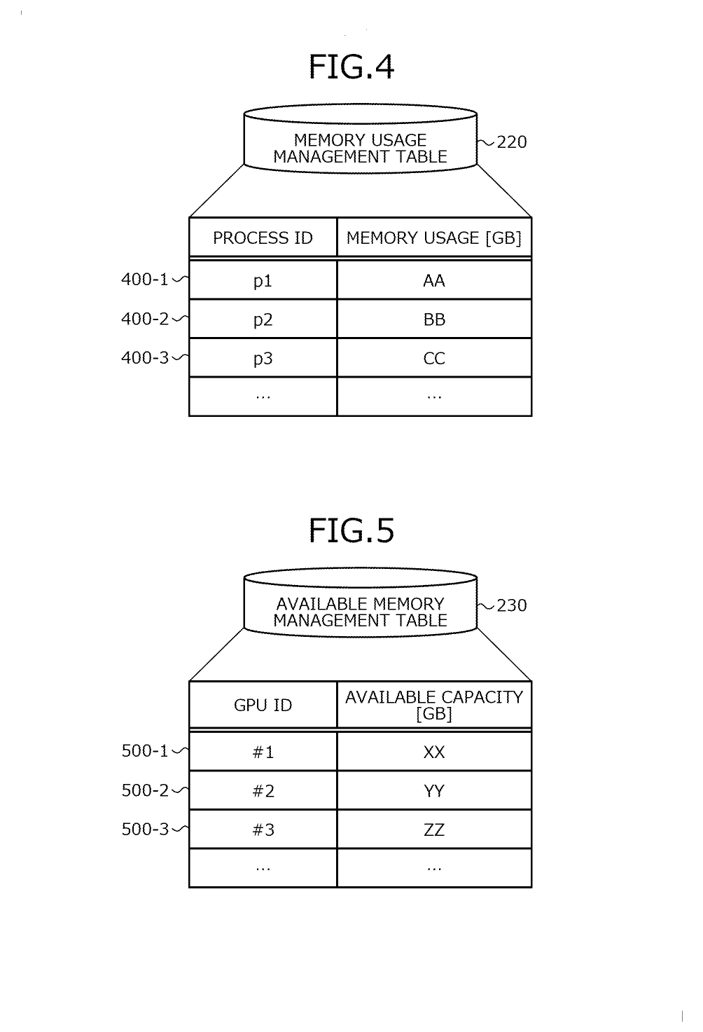

Here, the execution control device 201 is a computer that has a memory usage management table 220 and an available memory management table 230 and controls the execution of program processing. The execution control device 201 is, for example, a server. The contents stored in the memory usage management table 220 and the available memory management table 230 will be described later with reference to FIGS. 4 and 5.

The user terminal 202 is a computer used by a user of the information processing system 200. The user terminal 202 is, for example, a personal computer (PC), a tablet PC, or a smartphone.

The user terminal 202 may execute a user program in the execution control device 201 by, for example, transmitting the user program to the execution control device 201. The user program is a program to be executed and includes a process that is repeatedly executed using a machine learning model.

Here, while the execution control device 201 is provided separately from the user terminal 202, the present disclosure is not limited hereto. For example, the execution control device 201 may be implemented by the user terminal 202. Furthermore, the information processing system 200 may include multiple execution control devices 201 and user terminals 202.

Next, a hardware configuration example of the execution control device 201 will be described.

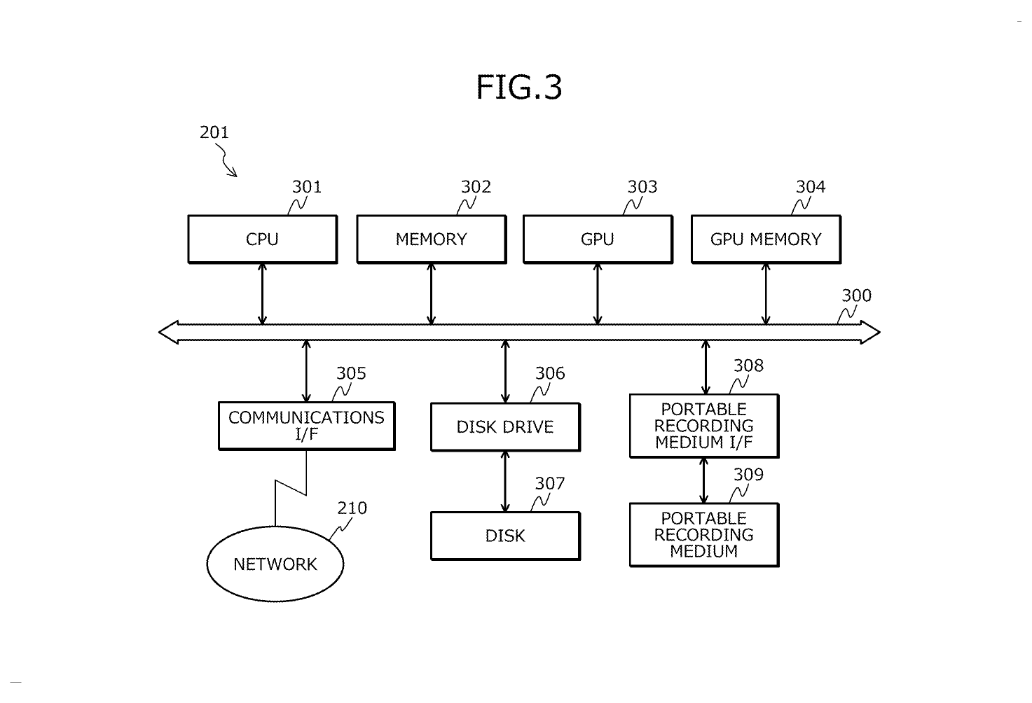

FIG. 3 is a block diagram depicting a hardware configuration example of the execution control device 201. In FIG. 3, the execution control device 201 has a CPU 301, a memory 302, a GPU 303, a GPU memory 304, a communication interface (I/F) 305, a disk drive 306, a disk 307, a portable recording medium I/F 308, and a portable recording medium 309. Moreover, the components are coupled to each other by a bus 300.

Here, the CPU 301 is responsible for the overall control of the execution control device 201. The GPU 303 performs arithmetic processing such as image processing and natural language processing. The CPU 301 and the GPUs 303 each may have multiple cores. The GPU 303 includes, for example, two or more GPUs (devices). The memory 302 includes, for example, a read only memory (ROM) and a random access memory (RAM). A program stored in the memory 302 is loaded onto the CPU 301, causing the CPU 301 to execute an encoded process. The GPU memory 304 is a memory dedicated to the GPU 303. The GPU memory 304 is, for example, a video RAM (VRAM).

In the following description, an example will be described in which the GPU 303 includes n GPUs (devices) (n: natural number of 2 or more). The n GPUs (devices) may be written as "GPUs #1 to #n," and any one of the GPUs #1 to #n may be written as a "GPU #i" (i=1, 2, ..., n). The memory of the GPU #i may be written as a "memory #i." The memory #i corresponds to the storage area in the GPU memory 304 that is occupied by the GPU #i.

The communications I/F 305 is coupled to the network 210 through a communication line and is coupled to an external computer (for example, the user terminal 202 depicted in FIG. 2) via the network 210. The communications I/F 305 manages an internal interface with the network 210 and controls the input and output of data from the external computer. The communications I/F 305 is, for example, a modem or a LAN adapter.

The disk drive 306 controls the reading and writing of data with respect to the disk 307, under the control of the CPU 301. The disk 307 stores data written thereto under the control of the disk drive 306. The disk 307 is, for example, a magnetic disk or an optical disk.

The portable recording medium I/F 308 controls the reading and writing of data with respect to the portable recording medium 309, under the control of the CPU 301. The portable recording medium 309 stores data written thereto under the control of the portable recording medium I/F 308. The portable recording medium 309 is, for example, a compact disc (CD)-ROM, a digital versatile disk (DVD), a universal serial bus (USB) memory, or the like.

In addition to the above-mentioned components, the execution control device 201 may have, for example, an input device, a display, a printer, a scanner, a microphone, a speaker, etc. Also, the execution control device 201 may omit, for example, the portable recording medium I/F 308 and the portable recording medium 309, etc., among the above-mentioned components.

Next, storage contents of the memory usage management table 220 and the available memory management table 230 of the execution control device 201 will be explained with reference to FIG. 4. The memory usage management table 220 and the available memory management table 230 are implemented by storage devices such as the memory 302 and the disk 307 depicted in FIG. 3.

FIG. 4 is an explanatory diagram depicting an example of the storage contents of the memory usage management table 220. In FIG. 4, the memory usage management table 220 has fields for a process ID and memory usage, and stores memory usage information (for example, memory usage information 400-1 to 400-3) as records by setting information in each field.

Here, the process ID indicates an identifier that uniquely identifies a process. A process corresponds to a user program. The memory usage indicates the memory usage when the process of a process (user program) is executed. The memory usage corresponds to the storage capacity of the storage area occupied by the process (user program). For example, the memory usage information 400-1 indicates the memory usage of the process p1 "AA [GB]."

FIG. 5 is an explanatory diagram depicting an example of the storage contents of the available memory management table 230. In FIG. 5, the available memory management table 230 has fields for a GPU ID and available capacity, and stores available memory information (for example, available memory information 500-1 to 500-3) as records by setting information in each field.

Here, the GPU ID indicates an identifier that uniquely identifies a GPU #i. The available capacity indicates available capacity of the memory #i of the GPU #i. The available capacity of the memory #i is the capacity of unused storage area of the memory #i. For example, available memory information 500-1 indicates the available capacity "XX [GB]" of a memory #1 of a GPU #1.

Next, an example of a functional configuration of the execution control device 201 will be described.

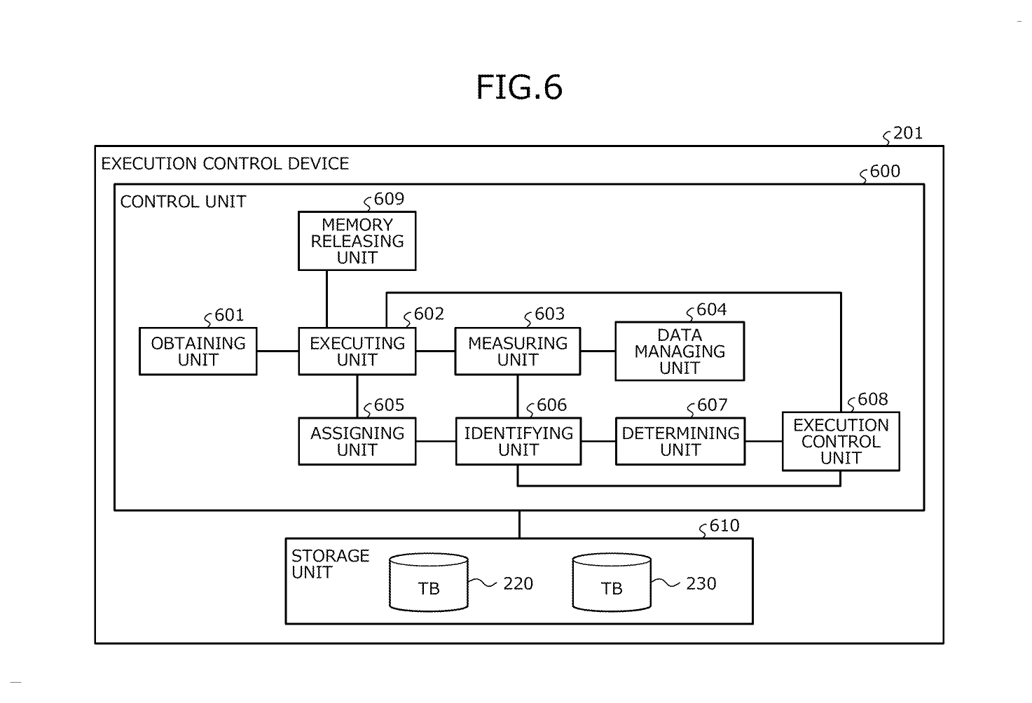

FIG. 6 is a block diagram depicting an example of the functional configuration of the execution control device 201. In FIG. 6, the execution control device 201 includes an obtaining unit 601, an executing unit 602, a measuring unit 603, a data managing unit 604, an assigning unit 605, an identifying unit 606, a determining unit 607, an execution control unit 608, a memory releasing unit 609, and a storage unit 610. The obtaining unit 601 to the memory releasing unit 609 are functions that constitute a control unit 600 and for example, the functions are implemented by having the CPU 301 or the GPU 303 execute programs stored in a storage device such as the memory 302, the GPU memory 304, the disk 307, and the portable recording medium 309 depicted in FIG. 3, or by the communications I/F 305. The processing results of each functional unit are stored to a storage device such as the memory 302 and the disk 307.

The storage unit 610 is implemented by a storage device such as the memory 302 and the disk 307. For example, the storage unit 610 stores therein the memory usage management table 220 depicted in FIG. 4 and the available memory management table 230 depicted in FIG. 5. Here, while a case where the storage unit 610 is included in the execution control device 201 will be described, the present disclosure is not limited hereto. For example, the storage unit 610 may be included in a computer different from the execution control device 201 and may be referred to by the execution control device 201 via the network 210.

The obtaining unit 601 obtains the target program. The target program is a program to be executed such as, for example, a user program. For example, the obtaining unit 601 obtains the target program by receiving he target program from the user terminal 202 depicted in FIG. 2. The target program may also be obtained by a user operation input using an input device (not depicted).

In the following description, the target program may be referred to as a "user program P." The user program P includes a process that is repeatedly executed using a machine learning model. The target program 110 depicted in FIG. 1 corresponds to the user program P, for example.

The executing unit 602 executes the obtained user program P under the control of the execution control unit 608. For example, the executing unit 602 makes a GPU request to the assigning unit 605 when executing the user program P. Here, the GPU request is a request to assign a GPU #i to the process of the user program P.

Then, according to the assignment result from the execution control unit 608, the executing unit 602 executes the process of the user program P by the CPU 301 or the GPU #i specified from the assignment result. A GPU request is made, for example, for each process that is repeatedly executed in the user program P. Note that the GPU request includes, for example, a process ID. The GPU request may also include memory usage.

The measuring unit 603 measures the memory usage of the process of the user program P. The memory usage corresponds to the capacity of the storage area occupied by the process of the user program P being executed. For example, when the process of the user program P is executed by the CPU 301, the memory usage corresponds to the capacity of the storage area in the memory 302 that is occupied by the process of the user program P.

When the process of the user program P is executed by the GPU #i, the memory usage corresponds to the capacity of the storage area in the memory #i of the GPU #i that is occupied by the process of the user program P. For example, the measuring unit 603 may measure the memory usage of the process of the user program P by using a performance counter.

Also, the measuring unit 603 may measure the memory usage only when the process of the user program P is executed for the first time. Also, the measuring unit 603 may measure the memory usage every time the process of the user program P is executed. Also, the measuring unit 603 may measure the memory usage when the process of the user program P is executed a predetermined number of times (for example, the first to fifth times).

The data managing unit 604 manages the memory usage of the process of the user program P. For example, the memory usage measured by the measuring unit 603 is recorded in the memory usage management table 220 depicted in FIG. 4 in association with the process ID of the user program P.

Also, the memory usage may be measured every time the user program P is executed or a predetermined number of times. In this case, the data managing unit 604 may calculate the average of the measured memory usage and record the calculated average memory usage in the memory usage management table 220 in association with the process ID of the user program P. Also, the data managing unit 604 may identify the maximum memory usage among the measured memory usages, and record the identified maximum memory usage in the memory usage management table 220 in association with the process ID of the user program P.

Also, there are cases where the processing content of the user program P does not cause a large difference in memory usage between processes executed repeatedly. In such a case, the data managing unit 604 may record in the memory usage management table 220, only the memory usage measured during the first execution.

The assigning unit 605 assigns resources for the process of the user program P. The resources are, for example, the CPU 301 and the GPU 303 that may be shared by two or more programs. For example, the assigning unit 605 performs a scheduling process to assign the CPU 301 or the GPU #i to the process of the user program P in response to a GPU request. Note that the process of the user program P is specified, for example, by a process ID included in the GPU request.

To explain in more detail, for example, the assigning unit 605 measures the performance values when the process of the user program P is executed by each of the CPU 301 and the GPU #i. Then, the assigning unit 605 determines whether to assign the CPU 301 or the GPU #i to the process of the user program P based on the measured performance values.

For example, when the performance value when executed by the GPU #i is higher than the performance value when executed by the CPU 301 by a threshold value or more, the assigning unit 605 may determine that the priority is high and assign the GPU #i to the process of the user program P. On the other hand, when the performance value when executed by the GPU #i is not higher than the performance value when executed by the CPU 301 by a threshold value or more, the assigning unit 605 may determine that the priority is low and assign the CPU 301 to the process of the user program P.

Note that any existing technique may be used as a scheduling process for assigning the CPU 301 or the GPU #i. However, when assigning the CPU 301 or the GPU #i, the assigning unit 605 may not take into account the available capacity of the memory 302 and the memory #i of the GPU #i.

When the GPU #i is assigned to the process of the user program P, the identifying unit 606 identifies the available capacity of the memory #i of the GPU #i. The available capacity of the memory #i is the capacity of the memory area in the memory #i that is not assigned to any program. For example, the identifying unit 606 may identify the available capacity of the memory #i of the GPU #i by inquiry of a management function such as a task manager.

More specifically, for example, the identifying unit 606 may identify the available capacity of the memory #i at a predetermined time interval (for example, an interval of several seconds to several tens of seconds) for each GPU #i included in the GPUs #1 to #n. The identified available capacity of the memory #i is stored to the available memory management table 230 depicted in FIG. 5 in association with, for example, the GPU ID of the GPU #i. Then, when the GPU #i is assigned to the process of the user program P, the identifying unit 606 may identify the available capacity of the memory #i of the GPU #i by referring to the available memory management table 230.

The determining unit 607 compares the available capacity of the memory #i of the specified GPU #i with the memory usage measured during the previous execution of the process of the user program P. Then, the information processing apparatus 101 determines whether the memory #i of the GPU #i is insufficient based on the result of the comparison.

For example, the determining unit 607 refers to the memory usage management table 220 to identify the memory usage corresponding to the process ID of the user program P. Then, the determining unit 607 compares the available capacity of the specified memory #i with the identified memory usage. Here, when the available capacity of the memory #i is equal to or greater than the memory usage, it may be determined that the memory #i is sufficient. On the other hand, when the available capacity of the memory #i is less than the memory usage, it may be determined that the memory #i is insufficient.

Furthermore, the determining unit 607 may determine that the memory #i is sufficient when a value obtained by subtracting the memory usage from the available capacity of the memory #i is equal to or greater than a predetermined value. On the other hand, when the value obtained by subtracting the memory usage from the available capacity of the memory #i is less than the predetermined value, it may be determined that the memory #i is insufficient. The predetermined value is a value greater than 0 and may be set arbitrarily.

Note that the memory usage of the user program P is not measured at the first (initial) execution of the process of the user program P. In this case, the determining unit 607 may determine that the memory #i is sufficient or may determine that the memory #i is insufficient.

When the memory #i of the GPU #i is sufficient, the execution control unit 608 executes the process of the user program P by the GPU #i. Further, when the memory #i of the GPU #i is insufficient, the execution of the process of the user program P by the GPU #i is put on hold until the storage area in the memory #i assigned to another program is released.

For example, when the memory #i of the GPU #i is sufficient, the execution control unit 608 notifies the executing unit 602 of an assignment result indicating that the GPU #i has been assigned, as a response to the GPU request. As a result, the executing unit 602 executes the process of the user program P using the GPU #i specified from the assignment result from the execution control unit 608.

Here, there are cases where the assigned GPU #i is the same as a previous GPU #j assigned during the previous execution of the process of the user program P (i=j). In such a case, the executing unit 602 executes the process of the user program P by the GPU #i using model data representing the machine learning model stored in the memory #i of the GPU #i.

Furthermore, when the memory #i of the GPU #i is insufficient, the execution control unit 608 holds execution of the process of the user program P by the GPU #i until, for example, a storage area in the memory #i is released and the available capacity in the memory #i becomes equal to or greater than the specified memory usage.

Then, in response to the end of the wait, the execution control unit 608 notifies the executing unit 602 of an assignment result indicating that the GPU #i has been assigned, as a response to the GPU request. As a result, the executing unit 602 executes the process of the user program P by the GPU #i specified from the assignment result from the execution control unit 608.

Note that the execution control unit 608 may end the wait when the storage area in the memory #i, which has been assigned to at least any other program, is released. Even in this case, it is expected that the occurrence of errors such as out-of-memory errors may be suppressed compared to when the process of the user program P is executed immediately after the GPU #i is assigned.

When the CPU 301 is assigned to the process of the user program P, the execution control unit 608 notifies the executing unit 602 of an assignment result indicating that the CPU 301 has been assigned, as a response to the GPU request. As a result, the executing unit 602 executes the process of the user program P by the CPU 301 specified from the assignment result from the execution control unit 608.

When the process of the user program P is executed for the first time, the execution control device 201 may omit the process of the identifying unit 606 and the determining unit 607 because the memory usage of the user program P has not been measured. In this case, the assigning unit 605 may assign the CPU 301 to the process of the user program P when the process of the user program P is executed for the first time (first time). This allows the execution control device 201 to prevent the GPU #i from being assigned to the process of the user program P despite the fact that the memory #i of the GPU #i is insufficient.

When the GPU #i is assigned to the process of the user program P, the memory releasing unit 609 determines whether the GPU #i is the same as the previous GPU #j assigned during the previous execution of the process of the user program P. Here, information identifying the previous GPU (e.g., GPU ID) is stored in the memory 302, for example, in association with information identifying a process (user program P) (e.g., process ID).

For example, when the GPU ID of the currently assigned GPU #i is the same as the GPU ID of the previous GPU #j, the memory releasing unit 609 judges that the currently assigned GPU #i is the same as the previous GPU #j (i=j). Furthermore, when the GPU ID of the currently assigned GPU #i is different from the GPU ID of the previous GPU #j, the memory releasing unit 609 determines that the currently assigned GPU #i is different from the previous GPU #j (i≠j).

Note that there are cases where the previous process of the user program P was executed by the CPU 301. In such a case, the memory releasing unit 609 does not need to determine whether the currently assigned GPU #i is the same as the previous GPU #j.

When the currently assigned GPU #i is different from the previous GPU #j, the memory releasing unit 609 releases the memory area assigned to the user program P in a memory #j of the previous GPU #j. The memory area assigned to the user program P is the memory area occupied by the user program P. The release of the memory area assigned to the user program P in the memory #j (memory release) may be performed, for example, by executing a memory release command.

For example, the memory releasing unit 609 releases a storage area in which the model data in the memory #j of the previous GPU #j, which is assigned to the user program P, is stored. The model data is information that indicates a machine learning model used in the process of the user program P, and includes, for example, information that specifies an algorithm and parameters (weight parameters) of the machine learning model.

To explain in more detail, for example, when the model data is different from the previous GPU #j, the memory releasing unit 609 transfers the model data from the memory #j of the previous GPU #j to the memory #i of the GPU #i. Then, the memory releasing unit 609 releases a storage area in which the model data in the memory #j of the previous GPU #j is stored.

The memory releasing unit 609 may shorten the model transfer time by directly transferring the model data between the memories #i and #j of the GPUs #i and #j. However, the memory releasing unit 609 may transfer model data from the memory #j of the previous GPU #j to the memory #i of the GPU #i via the CPU 301 or the memory 302.

Furthermore, when the CPU 301 is assigned to the process of the user program P, the memory releasing unit 609 may determine whether the GPU #j was assigned at the time of the previous execution of the process of the user program P. Then, if the GPU #j was assigned at the time of the previous execution, the memory releasing unit 609 releases the storage area assigned to the user program P in the memory #j of the previous GPU #j.

For example, the memory releasing unit 609 releases the storage area in which the model data in the memory #j of the previous GPU #j, which was assigned to the user program P, is stored. To explain in more detail, for example, the memory releasing unit 609 transfers model data from the memory #j of the previous GPU #j to the memory 302 of the CPU 301. Then, the memory releasing unit 609 releases the storage area in which the model data in the memory #j of the previous GPU #j is stored.

As described, the memory releasing unit 609 sets the timing of memory release of the GPU (previous GPU #j) to the beginning of the execution of the process of the user program P. As a result, when the same GPU #i (i=j) as in the previous execution is assigned, the execution control device 201 may reuse the model data in the memory #i on the GPU #i, and may omit model transfer.

However, among the data necessary for the execution of the process of the user program P, data other than the model data representing the machine learning model (input/output data) is often information that differs for each process of the user program P. For this reason, even when the same GPU as in the previous execution is assigned, it cannot be expected that the input/output data from the previous execution may be reused.

Therefore, when the process of the user program P by the GPU #i is completed, the memory releasing unit 609 may release the storage area in which the input/output data is stored, out of the storage area in the memory #i of the GPU #i that is assigned to the process of the user program P. This allows the execution control device 201 to secure available storage for the input/output data in the memory #i of the GPU #i, thereby preventing a situation in which the storage area is unnecessarily occupied.

Note that the functional units (obtaining unit 601 to memory releasing unit 609) of the execution control device 201 may be implemented by multiple computers (e.g., the execution control device 201, the user terminal 202, an execution device (not depicted), etc.) in the information processing system 200. In this case, communication between the functional units of the different computers is performed, for example, by transmission and reception between the functional units via the network 210. For example, the executing unit 602, the measuring unit 603, and the memory releasing unit 609 may be implemented by an execution device (not depicted) different from the execution control device 201. In this case, the execution device (not depicted) has a computing device equivalent to the CPU 301 and the GPU 303 (GPUs #1 to #n) used to execute the process of the user program P.

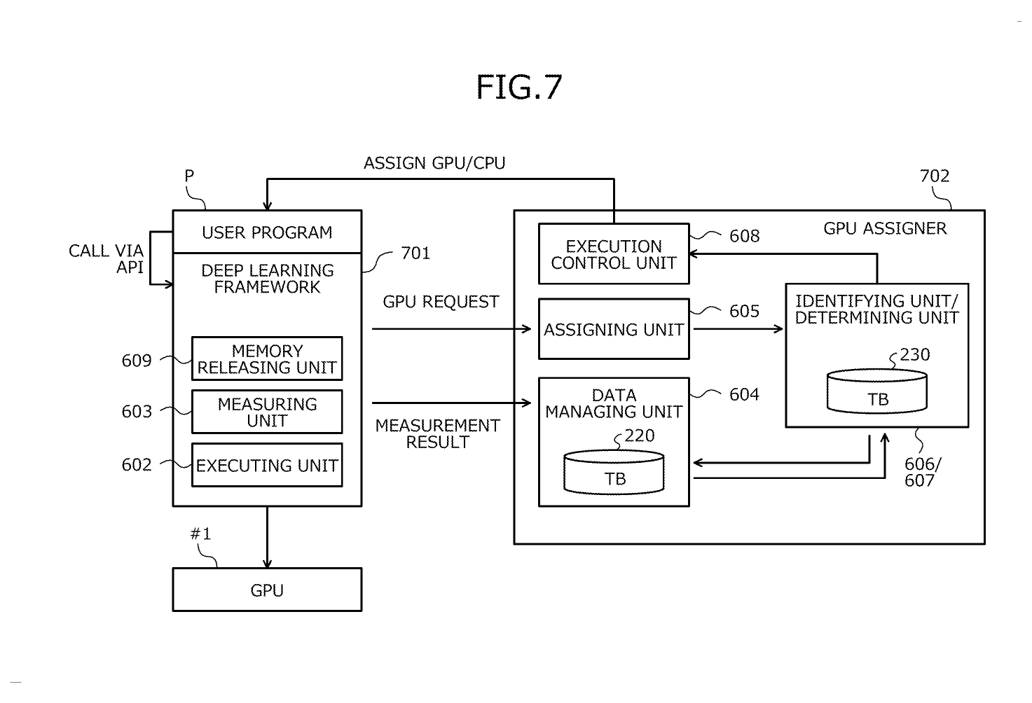

Next, an example of operation of the execution control device 201 will be described with reference to FIG. 7.

FIG. 7 is an explanatory diagram depicting an example of operation of the execution control device 201. In FIG. 7, the executing unit 602, the measuring unit 603, and the memory releasing unit 609 are implemented by a deep learning framework 701 of the execution control device 201. The deep learning framework 701 provides functions necessary for performing processing related to deep learning (training processing, estimation processing). The deep learning framework 701 is invoked, for example, by the user program P via an application programming interface (API).

The data managing unit 604, the assigning unit 605, the identifying unit 606, the determining unit 607, and the execution control unit 608 are implemented by a GPU assigner 702. The GPU assigner 702 is a function that manages the assignment of the GPU 303 (GPUs #1 to #n).

When the deep learning framework 701 executes the process of the user program P by the executing unit 602, the deep learning framework 701 makes a GPU request to the assigning unit 605. At this time, the deep learning framework 701 transmits to the data managing unit 604, the memory usage (measurement result) measured by the measuring unit 603 during the execution of the process of the user program P. Note that the memory usage (measurement result) may be included in the GPU request.

The GPU assigner 702 uses the data managing unit 604 to associate the memory usage (measurement result) received from the deep learning framework 701 with the process ID of the user program P and records the associated memory usage in the memory usage management table 220.

The GPU assigner 702 also uses the assigning unit 605 to perform scheduling processing for assigning the CPU 301 or the GPU #i to the process of the user program P in response to a GPU request. Here, it is assumed that the GPU #1 is assigned to the process of the user program P.

In this case, the GPU assigner 702 uses the identifying unit 606 to refer to the available memory management table 230 to identify the available capacity "XX [GB]" of the memory #1 of the GPU #1. Next, the GPU assigner 702, by using the determining unit 607, refers to the memory usage management table 220 and identifies the memory usage corresponding to the process ID of the user program P.

Here, the process ID of the user program P is "p1." In this case, the memory usage "AA [GB]" corresponding to the process ID "p1" of the user program P is identified. The GPU assigner 702, by using the determining unit 607, compares the identified available capacity "XX [GB]" of the memory #1 of the GPU #1 with the identified memory usage "AA [GB]." Then, the GPU assigner 702, by using the determining unit 607, determines whether the memory #1 of the GPU #1 is insufficient based on the result of the comparison.

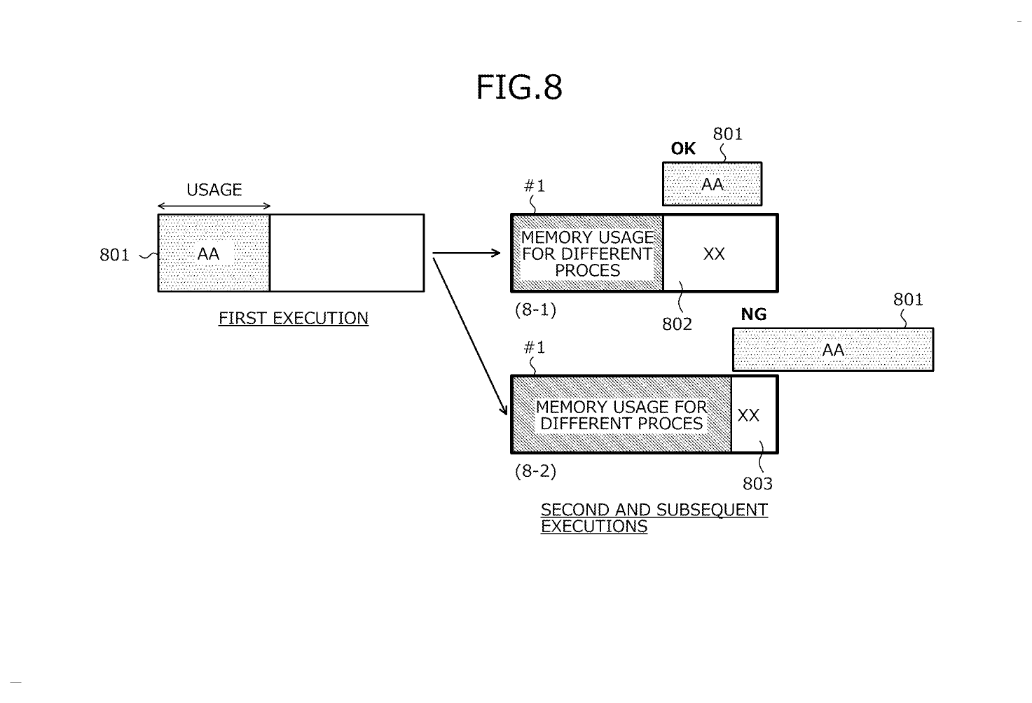

Here, an example of determining whether the memory #1 of the GPU #1 is insufficient will be described with reference to FIG. 8.

FIG. 8 is an explanatory diagram depicting an example of determining whether there is a shortage of available memory. In FIG. 8, memory usage 801 is the memory usage measured during the first execution of the process of the user program P, and corresponds to the identified memory usage "AA [GB]."

In the example of (8-1), the available capacity of the memory #1 is set as "available capacity 802." The available capacity 802 corresponds to the identified available capacity "XX [GB]." In this case, the GPU assigner 702 uses the determining unit 607 to compare the memory usage 801 with the available capacity 802 of the memory #1. Here, although a part of the memory #1 is being used by another process, the available capacity 802 of the memory #1 is equal to or larger than the memory usage 801 (XX≥AA). In this case, the GPU assigner 702 uses the determining unit 607 to determine that the memory #1 is not insufficient.

In the example of (8-2), the available capacity of the memory #1 is set to "available capacity 803." The available capacity 803 corresponds to the identified available capacity "XX [GB]." In this case, the GPU assigner 702 uses the determining unit 607 to compare the memory usage 801 with the available capacity 803 of the memory #1. Here, most of the memory #1 is being used by another process, and the available capacity 803 of the memory #1 is less than the memory usage 801 (XX<AA). In this case, the GPU assigner 702 uses the determining unit 607 to determine that the memory #1 is insufficient.

Returning to the explanation of FIG. 7, when the execution control unit 608 determines that the memory #1 of the GPU #1 is sufficient, the GPU assigner 702 notifies the executing unit 602 of an assignment result indicating that the GPU #1 has been assigned as a response to the GPU request.

Furthermore, when the execution control unit 608 determines that the memory #1 of the GPU #1 is insufficient, the GPU assigner 702 holds execution of the process of the user program P by the GPU #1 until the storage area in the memory #1 assigned to another program is released. Then, in response to the execution control unit 608 ending the wait, the GPU assigner 702 notifies the executing unit 602 of an assignment result indicating that the GPU #1 has been assigned as a response to the GPU request.

This allows the GPU assigner 702 to prevent errors such as out-of-memory from occurring due to failure to secure a memory area for storing data necessary for the execution of the process of the user program P.

The deep learning framework 701 determines whether the assigned GPU #1 is the same as the previous GPU #j assigned at the time of the previous execution of the process of the user program P by the memory releasing unit 609. Here, it is assumed that the assigned GPU #1 is the same as the previous GPU #j (j=1).

In this case, the deep learning framework 701 does not release the memory area assigned to the user program P in the memory #1 of the GPU #1 (previous GPU #j). Then, the deep learning framework 701 executes the process of the user program P by the GPU #1 specified by the assignment result by the executing unit 602.

This allows the deep learning framework 701 to reuse the model data in the memory #1 on the GPU #1, and model transfer may be omitted.

Note that, when the assigned GPU #1 is different from the previous GPU #j, the deep learning framework 701 uses the memory releasing unit 609 to release the storage area assigned to the user program P in the memory #j of the previous GPU #j.

For example, the deep learning framework 701 uses the memory releasing unit 609 to release the storage area in which the model data in the memory #j of the previous GPU #j, which was assigned to the user program P, is stored. Then, the deep learning framework 701 uses the executing unit 602 to execute the process of the user program P using the GPU #1 specified by the assignment result.

As a result, the deep learning framework 701 may release the storage area in the memory #j in which the model data that is not used in the current process due to a change in the assigned GPU is stored, thereby preventing a situation in which the storage area is unnecessarily occupied.

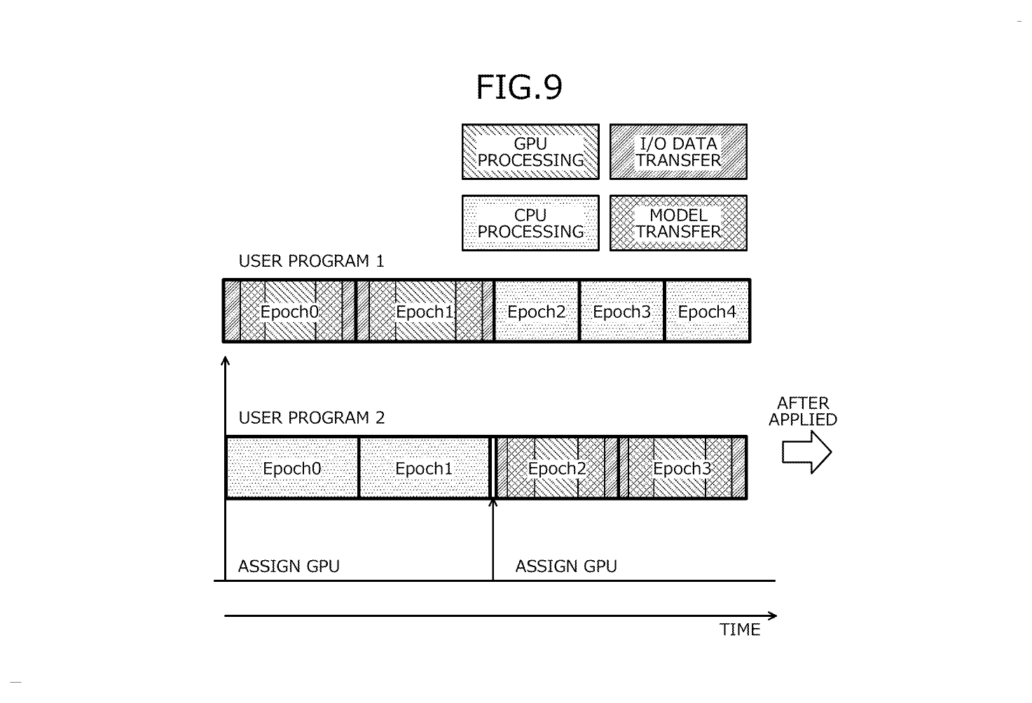

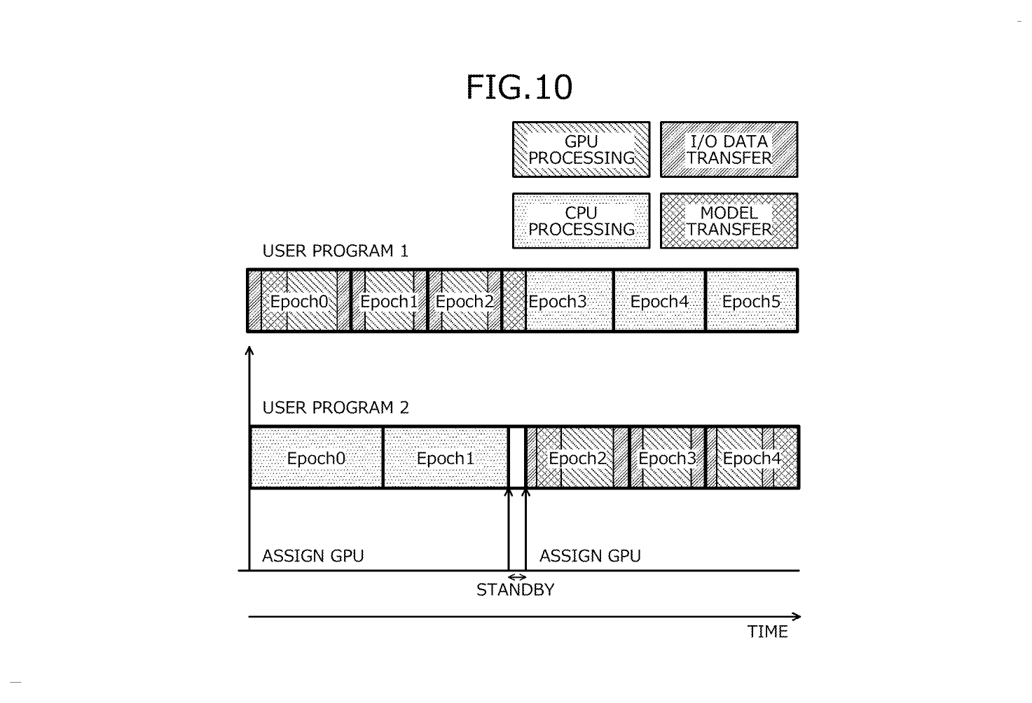

Next, an example of data transfer before and after application of the memory release processing will be described with reference to FIGS. 9 and 10.

FIGS. 9 and 10 are explanatory diagrams depicting an example of data transfer before and after application of this memory release processing method. FIG. 9 depicts an example of data transfer before application of the memory release processing method.

First, when Epoch 0 of the user program 1 is executed, a GPU is assigned to Epoch 0. In this case, input/output data transfer and model transfer are performed to transfer input/output data and model data to the memory of the GPU, and GPU processing (data processing by the GPU) is performed. Then, when the GPU processing is completed, model transfer and input/output data transfer are performed to move the model data and input/output data from the memory of the GPU.

Next, when Epoch 1 of the user program 1 is executed, a GPU is assigned to Epoch 1. In this case, input/output data transfer and model transfer are performed to transfer the model data and input/output data to the memory of the GPU, and GPU processing is performed. Then, when the GPU processing is completed, model transfer and input/output data transfer are performed to move the model data and input/output data from the memory of the GPU.

When the CPU is assigned to an Epoch (for example, Epochs 2 to 4) of the user program 1, the input/output data and model data are in the memory of the CPU, so the CPU processing is executed without input/output data transfer and model transfer. The same is true for the user program 2.

Thus, before the application of the memory release processing method, when the GPU is assigned, model transfer and input/output data transfer are performed to free up the GPU and memory release is performed every time one process of the user programs 1 and 2 is completed.

FIG. 10 depicts an example of data transfer after the application of the memory release processing method.

First, in executing Epoch 0 of the user program 1, the GPU is assigned to Epoch 0. In this case, input/output data transfer and model transfer are performed to transfer input/output data and model data to the memory of the GPU, and GPU processing (data processing by the GPU) is performed. Then, when the GPU processing is completed, input/output data transfer is performed to move the input/output data from the memory of the GPU. At this point, model transfer is not performed to move the model data.

Next, when Epoch 1 of the user program 1 is executed, the same GPU as the previous time is assigned to Epoch 1. In this case, input/output data transfer is performed to transfer the input/output data to the memory of the GPU, and GPU processing is performed. Model transfer is not performed because the model data may be reused. Then, when the GPU processing is completed, input/output data transfer is performed to move the input/output data from the memory of the GPU. At this point, model transfer is not performed to move the model data.

Next, when Epoch 2 of the user program 1 is executed, the same GPU as the previous time is assigned to Epoch 2. In this case, input/output data transfer is performed to transfer input/output data to the memory of the GPU, and GPU processing is performed. Model data may be reused, so model transfer is not performed. Then, when GPU processing is completed, input/output data transfer is performed to move input/output data from the memory of the GPU. At this point, model transfer is not performed to move model data.

Next, when Epoch 3 of the user program 1 is executed, the CPU is assigned to Epoch 3. In this case, model transfer is performed to move model data from the memory of the GPU during execution of Epoch 2, and CPU processing is performed.

After that, when the CPU is assigned to Epochs 4 and 5 of the user program 1, the input/output data and model data are in the memory of the CPU, so CPU processing is performed without input/output data transfer and model transfer.

As described, after application of the memory release processing method, by setting the timing of GPU memory release to the beginning of execution of the processing (Epoch) of the user program 1, when the same GPU as in the previous execution is assigned, the model data in the memory of the GPU may be reused, and model transfer may be omitted. As a result, after application of the memory release processing method, it is possible to execute Epochs 0 to 2 in approximately the same time as the time necessary for execution of Epochs 0 and 1 before application of the memory release processing method.

The same is true for the user program 2. However, when a GPU is assigned to Epoch 2 of the user program 2 and the memory of that GPU is insufficient, the execution of Epoch 2 is put into a standby state until another program (for example, the user program 1) releases the memory.

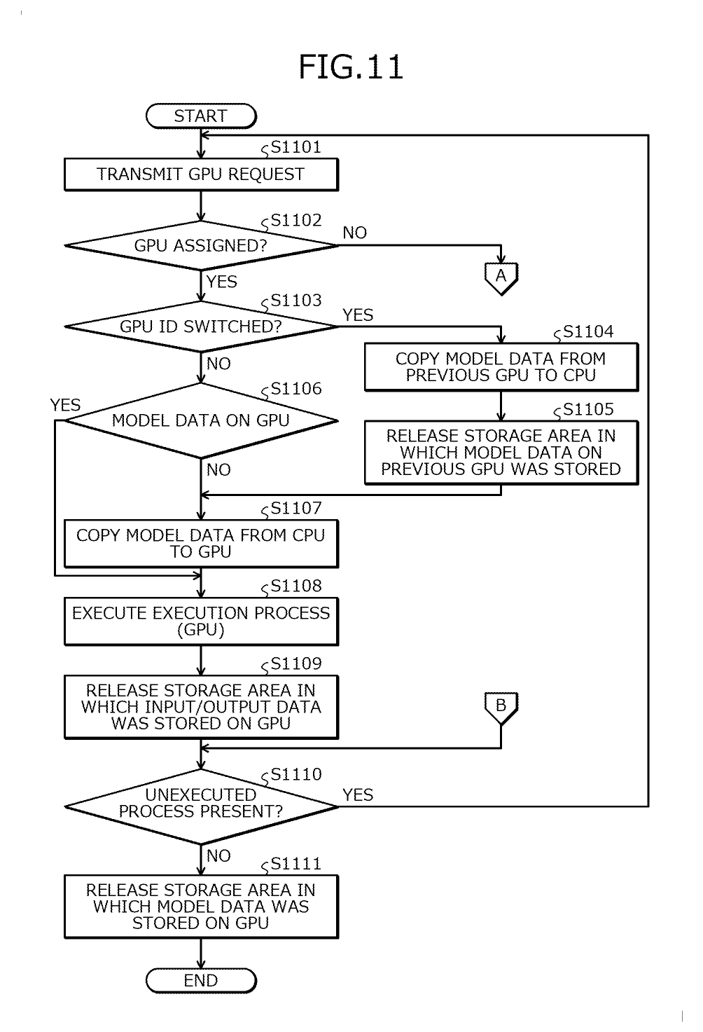

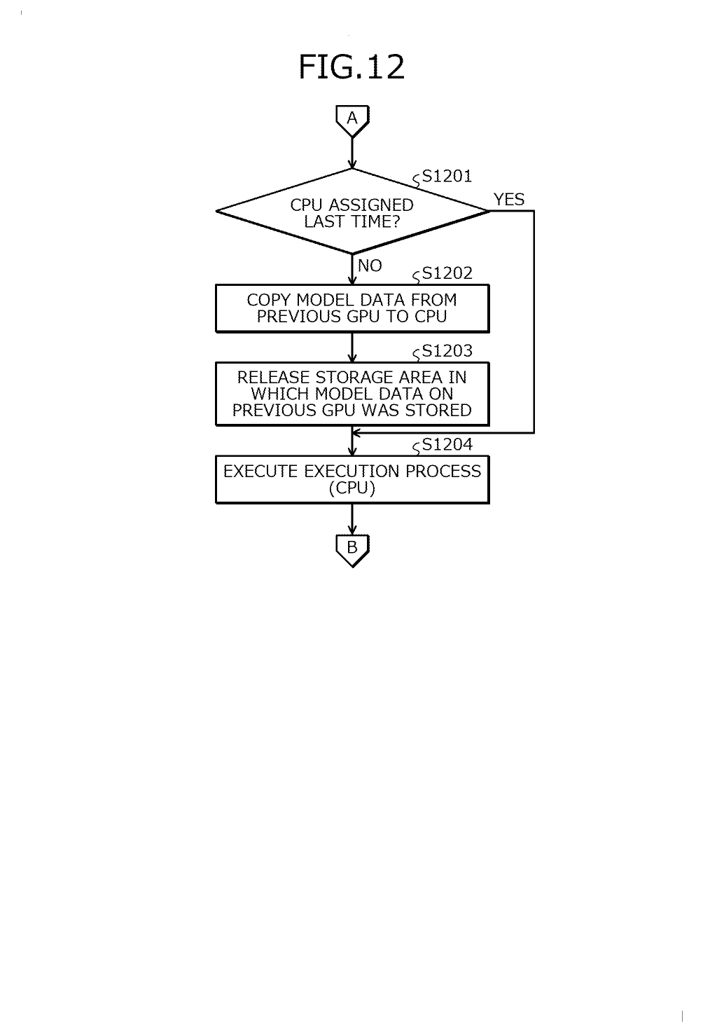

Next, various processing procedures of the execution control device 201 will be described. First, the memory release processing procedure of the execution control device 201 will be described with reference to FIGS. 11 and 12. The memory release process of the execution control device 201 is executed, for example, by the deep learning framework 701 (executing unit 602, measuring unit 603, and memory releasing unit 609) depicted in FIG. 7.

FIGS. 11 and 12 are flowcharts depicting an example of the memory release processing procedure of the execution control device 201. In the flowchart of FIG. 11, first, the execution control device 201 transmits a GPU request to the GPU assigner 702 (assigning unit 605) when executing the process of the user program P (step S1101). The GPU request includes, for example, the process ID and memory usage of the user program P.

Next, the execution control device 201 determines whether the GPU #i has been assigned to the process of the user program P (step S1102). For example, when the execution control device 201 receives an assignment result indicating that the GPU #i has been assigned, the execution control device 201 determines that the GPU #i has been assigned to the process of the user program P. Also, when the execution control device 201 receives an assignment result indicating that the CPU 301 has been assigned, the execution control device 201 determines that the GPU #i has not been assigned to the process of the user program P.

When the GPU #i has been assigned (step S1102: YES), the execution control device 201 determines whether the GPU ID of the GPU #i has been switched from the previous GPU (step S1103). The previous GPU is the GPU #j that was assigned during the previous execution of the process of the user program P.

When the GPU ID has been switched (step S1103: YES), the execution control device 201 copies the model data from the memory #j of the previous GPU #j to the memory 302 of the CPU 301 (step S1104). Then, the execution control device 201 releases the storage area in which the model data in the memory #j on the previous GPU #j is stored (step S1105), and proceeds to step S1107.

At step S1104, the execution control device 201 may directly transfer the model data between the memories #i and #j of the GPUs #i and #j. In this case, the execution control device 201 may omit the process at step S1107.

At step S1103, when the GPU ID has not been switched (step S1103: NO), the execution control device 201 determines whether there is model data in the memory #i on the assigned GPU #i (step S1106). Here, when there is model data (step S1106: YES), the execution control device 201 proceeds to step S1108.

On the other hand, when there is no model data (step S1106: NO), the execution control device 201 copies the model data from the memory 302 of the CPU 301 to the memory #i on the GPU #i (step S1107). Then, the execution control device 201 executes the execution process (GPU) of the user program P (step S1108). The execution process (GPU) of the user program P is to execute the process of the user program P by the GPU #i.

Next, the execution control device 201 releases the storage area in the memory #i on the GPU #i, i.e., the storage area in which the input/output data is stored (step S1109). Then, the execution control device 201 determines whether there is an unexecuted process of the user program P (step S1110). Here, when there is an unexecuted process (step S1110: YES), the execution control device 201 returns to step S1101.

On the other hand, when there is no unexecuted processing (step S1110: NO), the execution control device 201 releases the storage area in which the model data is stored in the memory #i on the assigned GPU #i (step S1111), and ends the series of processes according to this flowchart. However, when there is no model data in the memory #i on the GPU #i, the execution control device 201 skips the process at step S1111.

Also, when the GPU #i is not assigned at step S1102 (step S1102: NO), the execution control device 201 proceeds to step S1201 depicted in FIG. 12.

In the flowchart of FIG. 12, first, the execution control device 201 determines whether the CPU 301 was assigned when the process of the user program P was executed last time (step S1201). In other words, the execution control device 201 determines whether the GPU #j was assigned when the process of the user program P was executed last time.

Here, when the CPU 301 has been assigned (step S1201: YES), the execution control device 201 proceeds to step S1204.

On the other hand, when the CPU 301 has not been assigned (step S1201: NO), the execution control device 201 copies model data from the memory #j of the previous GPU #j to the memory 302 of the CPU 301 (step S1202). Next, the execution control device 201 releases the storage area in which the model data in the memory #j on the previous GPU #j was stored (step S1203).

Then, the execution control device 201 executes the execution process (CPU) of the user program P (step S1204), and after the end, proceeds to step S1110 depicted in FIG. 11. The execution process (CPU) of the user program P is to execute the process of the user program P by the CPU 301.

As a result, when the execution control device 201 repeatedly executes the process of the user program P, the timing of releasing the memory of the assigned GPU #i is set to the beginning of the execution of the process of the user program P, thereby improving the utilization efficiency of the GPU #i.

Note that, at step S1103, when the GPU ID is switched (step S1103: YES), and the CPU 301 was assigned during the previous execution of the process of the user program P, the execution control device 201 may skip the process at steps S1104 and S1105.

Also, the execution control device 201 measures the memory usage of the process of the executed user program P, for example, during the initial (first) execution of the process of the user program P. Then, the execution control device 201 may include the measured memory usage (measurement result) in the GPU request when executing the process of the user program P from the next time onward.

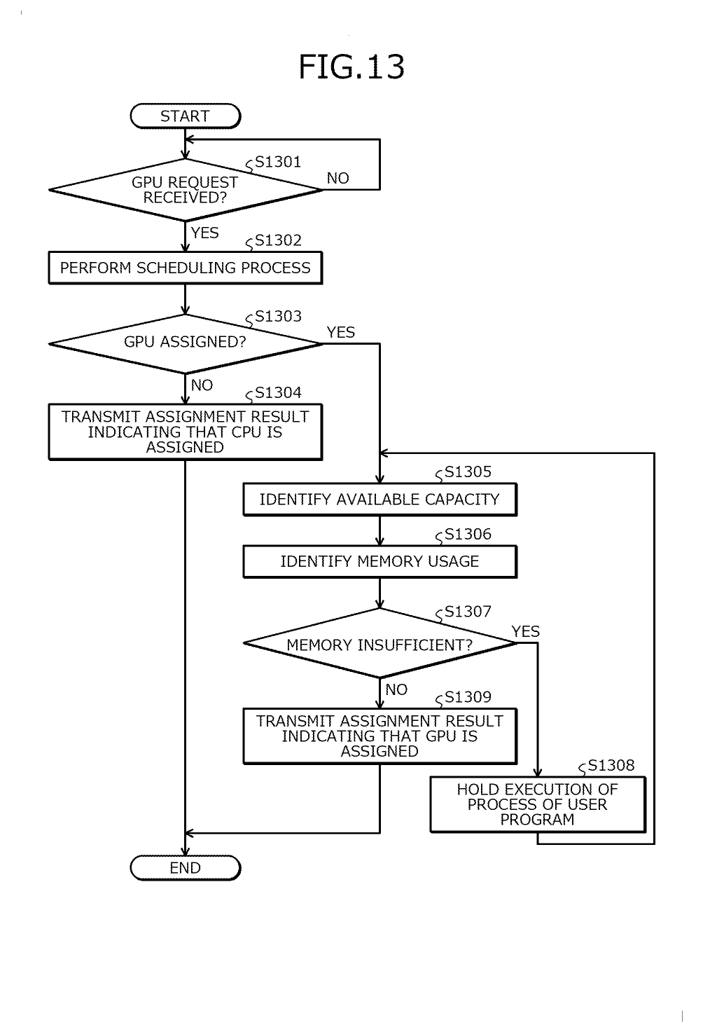

Next, the execution control processing procedure of the execution control device 201 will be described with reference to FIG. 13. The execution control process of the execution control device 201 is executed by, for example, the GPU assigner 702 (the data managing unit 604, the assigning unit 605, the identifying unit 606, the determining unit 607, and the execution control unit 608) depicted in FIG. 7.

FIG. 13 is a flowchart depicting an example of the execution control process procedure of the execution control device 201. In the flowchart of FIG. 13, first, the execution control device 201 determines whether a GPU request has been received from the deep learning framework 701 (the executing unit 602) (step S1301). Here, the execution control device 201 waits to receive a GPU request (step S1301: NO).

Then, when the execution control device 201 receives a GPU request (step S1301: YES), the execution control device 201 performs a scheduling process to assign the CPU 301 or the GPU #i to the process of the user program P (step S1302). The process of the user program P is specified, for example, by the process ID included in the GPU request.

Note that, for example, when the GPU request includes memory usage, the execution control device 201 records the memory usage included in the GPU request in the memory usage management table 220 in association with the process ID of the user program P.

Next, the execution control device 201 determines whether the GPU #i has been assigned to the process of the user program P (step S1303). Here, when the CPU 301 is assigned (step S1303: NO), the execution control device 201 transmits an assignment result indicating that the CPU 301 is assigned to the deep learning framework 701 (step S1304), and ends a series of processes according to this flowchart.

On the other hand, if the GPU #i is assigned (step S1303: YES), the execution control device 201 identifies the available capacity of the memory #i of the GPU #i (step S1305). Next, the execution control device 201 refers to the memory usage management table 220 to identify the memory usage corresponding to the process ID of the user program P (step S1306).

Then, the execution control device 201 determines whether the memory #i of the GPU #i is insufficient based on the result of comparing the identified available capacity of the memory #i of the GPU #i with the measured memory usage (step S1307).

Here, when the memory #i is insufficient (step S1307: YES), the execution control device 201 holds the execution of the process of the user program P by the GPU #i until the storage area in the memory #i assigned to another program is released (step S1308), and proceeds to step S1305.

Also, when the memory #i of the GPU #i at step S1307 is sufficient (step S1307: NO), the execution control device 201 transmits an assignment result indicating that the GPU #i has been assigned to the deep learning framework 701 (step S1309), and ends a series of processes according to this flowchart.

This allows the execution control device 201 to prevent errors caused by a shortage of memory in the GPU #i when assigning the GPU #i to the process of the user program P.

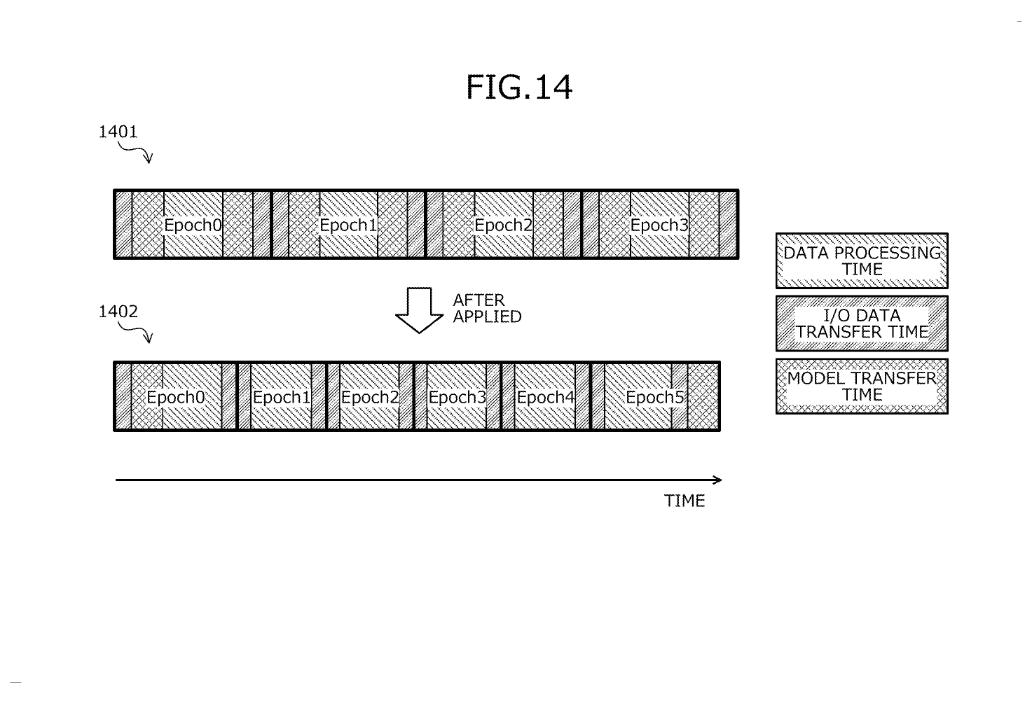

Next, an example of a change in the GPU usage rate will be described with reference to FIG. 14.

FIG. 14 is an explanatory diagram depicting an example of a change in GPU usage rate. FIG. 14 depicts a processing image when the processing (Epoch) of the user program P is repeatedly executed by the same GPU. A processing image 1401 depicts an image of the processing on the GPU (Epoch 0 to 3) before the application of the memory release processing method.

A processing image 1402 depicts an image of the processing on the GPU (Epoch 0 to 5) after the application of the memory release processing method. In the processing image 1402, since the model transfer time is reduced, more processing may be executed in the same time as the processing image 1401, and the GPU usage rate is improved. According to the processing image 1402, it may be seen that the more consecutive executions are performed by the same GPU, the higher the processing efficiency is.

As described above, according to the execution control device 201 according to the embodiment, when the GPU #i is assigned to the process of the user program P, the available capacity of the memory #i of the GPU #i may be identified. The user program P includes a process that is repeatedly executed using a machine learning model. The GPU #i is one of the GPUs 303 (GPUs #1 to #n) that may be shared by two or more programs. In addition, the execution control device 201 may determine whether the memory #i of the GPU #i is insufficient based on a result of comparing the available capacity of the memory #i of the specified GPU #i with the memory usage measured during the previous execution of the process of the user program P. For example, when the available capacity of the memory #i is equal to or greater than the memory usage, the execution control device 201 determines that f the memory #i is not insufficient. On the other hand, when the available capacity of the memory #i is less than the memory usage, the execution control device 201 determines that the memory #i is insufficient. Then, according to the execution control device 201, when the memory #i of the GPU #i is not insufficient, the process of the user program P may be executed by the GPU #i. Furthermore, according to the execution control device 201, when the memory #i of the GPU #i is insufficient, the execution of the process of the user program P by the GPU #i may be put on hold until the storage area in the memory #i assigned to another program is released.

As a result, when the execution control device 201 assigns the GPU #i to the process of the user program P, it is possible to suppress the occurrence of an error due to a failure to secure a storage area necessary for the execution of the process of the user program P, and to improve the utilization rate of the GPU #i.

Furthermore, according to the execution control device 201, when the GPU #i is assigned to the process of the user program P, it is possible to determine whether the GPU #i is the same as the previous GPU #j assigned at the time of the previous execution of the process of the user program P. Then, according to the execution control device 201, when the GPU #i is different from the previous GPU #j, it is possible to release the storage area assigned to the user program P in the memory #j of the previous GPU #j. For example, the execution control device 201 releases a storage area in which model data representing a machine learning model in the memory #j of the previous GPU #j, which was assigned to the user program P, is stored.

As a result, when the execution control device 201 repeatedly executes the process of the user program P, the timing of memory release of the GPU #i may be set to the start of the execution of the process of the user program P. Therefore, when the same device (GPU #i) is used continuously, the execution control device 201 may reuse the model data, reduce the number of model transfers, and improve the utilization efficiency of the GPU #i.

Furthermore, according to the execution control device 201, when the GPU #j is the same as the previous GPU #j, the GPU #i may execute the process of the user program P using the model data representing the machine learning model stored in the memory #i of the GPU #i.

As a result, the execution control device 201 may reuse the model data in the memory #i on the GPU #i, and can reduce the number of model transfers that become a bottleneck when using a large-scale machine learning model, thereby improving the efficiency of use of the GPU #i.

Furthermore, according to the execution control device 201, when the memory #i of the GPU #i is insufficient, the execution of the process of the user program P by the GPU #i may be put on hold until the storage area in the memory #i assigned to other programs is released and the available capacity in the memory #i becomes at least equal to or greater than the memory usage.

As a result, the execution control device 201 may put on hold the execution of the process of the user program P until the storage capacity used during the previous execution of the process of the user program P is secured, thereby preventing the occurrence of an error such as out of memory.

Furthermore, according to the execution control device 201, when the process of the user program P by the GPU #i is completed, the storage area in the memory #i of the GPU #i assigned to the process of the user program P, i.e., the memory #i in which the input/output data is stored, may be released. The input/output data is data necessary for executing the process of the user program P, other than the model data representing the machine learning model.

As a result, the execution control device 201 may secure available storage for the input/output data in the memory #i of the GPU #i, and prevent the storage area in the memory #i from being wasted.

Furthermore, according to the execution control device 201, when the CPU 301 is assigned to the process of the user program P among the CPU 301 and the GPU 303 (GPUs #1 to #n), each of which may be shared by two or more programs, it is possible to determine whether the GPU #j was assigned at the time of the previous execution of the process of the user program P. Then, according to the execution control device 201, when the GPU #j was assigned at the time of the previous execution, the storage area assigned to the user program P in the memory #j of the GPU #j assigned at the time of the previous execution may be released. For example, the execution control device 201 releases the storage area in which the model data representing the machine learning model in the memory #j of the previous GPU #j, which was assigned to the user program P, was stored.

As a result, when the CPU 301 is assigned to the process of the user program P, the execution control device 201 may release the memory of the GPU #j assigned during the previous execution.

Thus, according to the execution control device 201 according to the embodiment, when the process of the user program P is repeatedly executed using the CPU 301 and the GPU 303 that may be shared by two or more programs, the number of model transfers may be reduced and the usage rate of the GPU #i may be improved, and the user program P may be executed at high speed.

For example, even in a system in which resources are shared by multiple users, the execution control device 201 may efficiently execute repeated process of the user program P while switching between the CPU 301 and the GPU 303. Therefore, the execution control device 201 may quickly perform learning of machine learning models in application development such as artificial intelligence (AI) and advanced image recognition that uses the GPU 303.

In the above description, while the CPU 301 and the GPU 303 are taken as an example of a computing device that executes a program, the present disclosure is not limited to this. For example, a computing device such as a neural network processing unit (NPU) may be used instead of the GPU 303, or a computing device such as an NPU may be used together with the CPU 301 and the GPU 303.

The memory release processing method described in the present embodiment may be implemented by executing a prepared program on a computer such as a personal computer and a workstation. The program is stored on a non-transitory, computer-readable recording medium such as a hard disk, a flexible disk, a compact disc read-only memory (CD-ROM), a magneto-optical (MO) disc, and a digital versatile disc (DVD), read out from the computer-readable medium, and executed by the computer. The program may be distributed through a network such as the Internet.

The information processing device 101 (execution control device 201) described in the present embodiment may be realized by an application specific integrated circuit (ASIC) such as a standard cell or a structured ASIC, or a programmable logic device (PLD) such as a field-programmable gate array (FPGA).

According to one aspect of the present disclosure, an effect of improving the utilization rate of GPUs may be achieved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing therein a memory release processing program for causing a computer to execute a process, the process comprising:
identifying an available capacity of a memory of any GPU sharable by two or more programs including a target program having a process that is repeatedly executed using a machine learning model, the available capacity being identified when the any GPU is assigned to the process of the target program;
determining whether the memory is insufficient based on a result of comparison of the identified available capacity of the memory and a memory usage measured during a previous execution of the process of the target program;
executing the process of the target program by the any GPU when the memory is sufficient; and
holding execution of the process of the target program by the any GPU, when the memory is insufficient, the execution of the process being held until, in the memory, a storage area assigned to another program is released.

2. The computer-readable recording medium according to claim 1, the process further comprising:
determining whether the any GPU is a most-recent-used GPU assigned for a most-recent execution of the process of the target program, when the any GPU is assigned to the process of the target program; and
releasing, in a memory of the most-recently-used GPU, a memory area assigned to the target program, the memory area being released when the any GPU is different from the most-recent GPU.

3. The computer-readable recording medium according to claim 2, wherein the releasing includes releasing, in the memory of the most-recent GPU, the memory area that is assigned to the target program and that stores therein model data representing the machine learning model.

4. The computer-readable recording medium according to claim 2, wherein the executing includes:
executing the process of the target program by the any GPU, using the model data representing the machine learning model stored in the memory of the any GPU, when the any GPU is the most-recently-used GPU.

5. The computer-readable recording medium according to claim 1, wherein
the determining includes:
determining that the memory is sufficient, when the available capacity of the memory is equal to or greater than the memory usage; and
determining that the memory is insufficient, when the available capacity of the memory is less than the memory usage.

6. The computer-readable recording medium according to claim 1, wherein
the holding includes holding the execution of the process of the target program by the any GPU until the storage area in the memory assigned to the another program is released and the available capacity of the memory becomes at least equal to or greater than the memory usage.

7. The computer-readable recording medium according to claim 1, the process further comprising releasing, in the memory of the any GPU, a storage area that is assigned to the target program and stores therein data other than model data representing the machine learning model, when the execution of the process of the target program by the any GPU is completed.

8. The computer-readable recording medium according to claim 1, the process further comprising:
determining whether, among a CPU and a GPU sharable by the two or more programs, the GPU was assigned for a most-recent execution of the process of the target program, when the CPU is assigned to the process of the target program; and
releasing, in a memory of the GPU that was assigned for the most-recent execution, a memory area assigned to the target program, when determining that the GPU was assigned for the most-recent execution.

9. A memory release processing method executed by a computer, the memory release processing method comprising:
identifying an available capacity of a memory of any GPU sharable by two or more programs including a target program having a process that is repeatedly executed using a machine learning model, the available capacity being identified when the any GPU is assigned to the process of the target program;
determining whether the memory is insufficient based on a result of comparison of the identified available capacity of the memory and a memory usage measured during a previous execution of the process of the target program;
executing the process of the target program by the any GPU when the memory is sufficient; and
holding execution of the process of the target program by the any GPU, when the memory is insufficient, the execution of the process being held until, in the memory, a storage area assigned to another program is released.

10. An information processing device, comprising:
a memory; and
a processor coupled to the memory, the processor configured to:
identify an available capacity of a memory of any GPU sharable by two or more programs including a target program having a process that is repeatedly executed using a machine learning model, the available capacity being identified when the any GPU is assigned to the process of the target program;
determine whether the memory is insufficient based on a result of comparison of the identified available capacity of the memory and a memory usage measured during a previous execution of the process of the target program;
execute the process of the target program by the any GPU when the memory is sufficient; and
hold execution of the process of the target program by the any GPU, when the memory is insufficient, the execution of the process being held until, in the memory, a storage area assigned to another program is released.
